(19) United States
(12) Patent Application Publication
(10) Pub. No.: US 2006/0268967 A1
(43) Pub. Date: Nov. 30, 2006

(54) Supplying instruction to operational stations

(75) Inventor: Pierre Marc Lucien Drezet, Sheffield (GB)

Correspondence Address: HARNESS, DICKEY & PIERCE, P.L.C., P.O. BOX 828, BLOOMFIELD HILLS, MI, 48303, US

(73) Assignee: Pierre Marc Lucien Drezet, Sheffield (GB)

(21) Appl. No.: 11/412,035

(22) Filed: Apr. 26, 2006

(30) Foreign Application Priority Data
Apr. 27, 2005 (GB) 0508498.3

(51) Int. Cl. H04B 17/00

(52) U.S. Cl. 375/224

(57) ABSTRACT

A method of supplying (1419, 1420) instructions to operational stations to operational stations (1501, 1502) is disclosed. Operations to be performed at said operational stations are defined as a graphical data floe diagram (1401). The data flow diagram is converted into sets of system description data. A respective set of instructions is downloaded to each of the operational stations. At each operational, station instructions are parsed to populate a data table (1503) and an event table (1504). The execution of events is scheduled in accordance with predetermined priority definitions and the events are executed in accordance with the scheduling step.

### BACKGROUND OF THE INVENTION

The present invention relates to a method of supplying instructions to a plurality of operational stations. The present invention also relates to a method of transforming a data flow diagram into system description data suitable for configuring a processing device.

### DESCRIPTION OF THE RELATED ART

A process for automatically producing a computer program in machine assembly language directly from a two-dimensional network representing the flow of data and control logic is described in U.S. Pat. No. 4,315,315. The network is used to represent the desired data processing to be programmed involving graphical representations. Basic data processing data circuit elements constitute the building blocks for the data flow circuits. These elements are functionally equivalent to hardware digital processing operations but are defined as a set of computer instructions.

### BRIEF SUMMARY OF THE INVENTION

According to an aspect of the present invention, there is provided a method of supplying instructions to a plurality of operational stations, comprising the steps of: defining operations as a graphical data flow diagram; converting the graphical representations into sets of data flow commands; supplying a respective set of said data flow commands to each operational station; at each operational station, acting upon said data flow commands by populating executable objects; and calling said executable objects in response to traversing an event table.

### BRIEF DESCRIPTION OF THE SEVERAL VIEWS OF THE DRAWINGS

FIG. 1 shows operational stations configured in the network for receiving instructions;

FIG. 2 illustrates a data processing system;

FIG. 3 details a programming environment identified in FIG. 2;

FIG. 4 details a workspace identified in FIG. 3;

FIG. 5 details an event handler shown in FIG. 2;

FIG. 6 illustrates data structures as used in a preferred embodiment;

FIG. 7 shows an example of a single processing system;

FIG. 8 shows an example of a more complex object compared to that shown in FIG. 7;

FIG. 9 illustrates a flow chart of the processing undertaken by an embodiment of the event handling system shown in FIG. 2;

FIG. 10 shows an arrangement of data tables;

FIG. 11 shows a scheduling scheme;

FIG. 12 shows a further scheduling scheme;

FIG. 13 shows a further scheduling scheme;

FIG. 14 shows an embodiment of a programming environment;

FIG. 15 shows an embodiment of an event handling system; and

FIG. 16 shows an embodiment of the resource reservation scheduling algorithm.

### DETAILED DESCRIPTION OF A PREFERRED EMBODIMENT

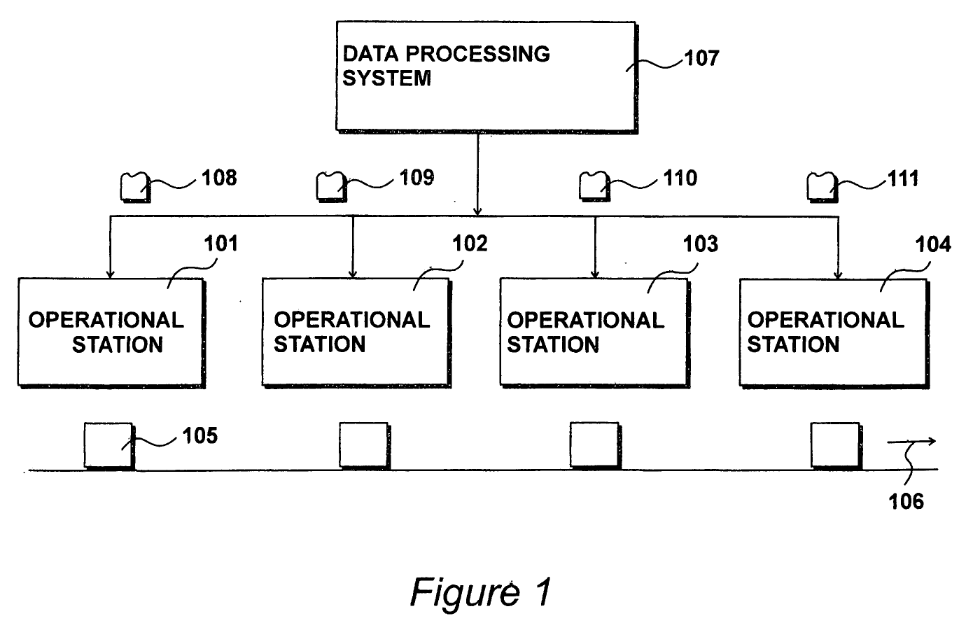

Operational stations 101 to 104 are illustrated in FIG. 1. The operational stations 101 to 104 each perform a specific operation upon a workpiece, such as workpiece 105, which is then moved in the direction of arrow 106 so that a further operational function may be conducted upon workpiece 105 at station 102. Thus, on the next cycle, a further operation is performed at station 103 whereafter, on the next cycle, a final operation is performed at station 104. At a data processing system 107, operations to be performed at the operational stations 101 to 104 are defined as a graphical data flow diagram. These graphical representations are converted into system description data, or sets of system description data when a plurality of stations are present. Thereafter, a respective set of data is supplied to each operational station. Thus, as illustrated in the FIG. 1, operational station 101 receives description data 108, operational station 102 receives description data 109, operational station 103 receives description data 110 and operational station 104 receives description data 111. All of the sets of description data flow originate from the data processing system 107. After the downloading of this description data, the data is parsed locally and it is not necessaery to maintain communication.

At each of the operational stations, the description data are acted upon by populating executable objects. Thereafter, at the operational station, executable objects are called in response to traversing an event table.

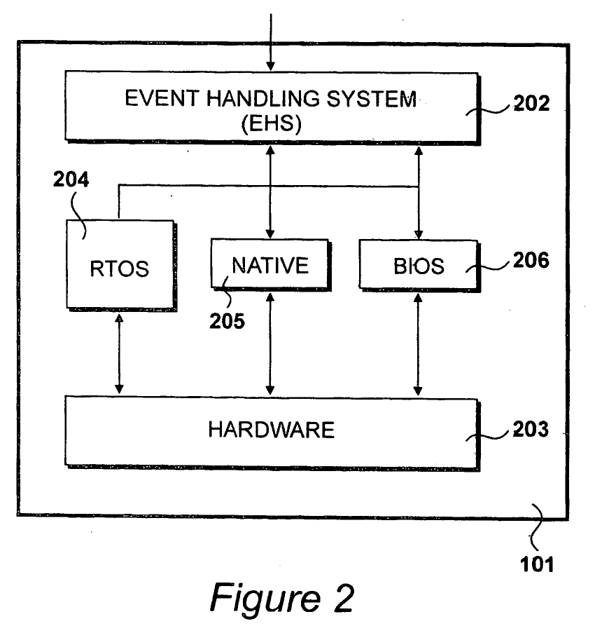

An example of an operating system is detailed in FIG. 2. The operational station an event handling system 202, coupled to hardware resources 203 via instructions such as a real-time operating system 204, native instructions 205 or a basic input output system (BIOS) 206.

At the application level within data processing system 107, data flow programming techniques are provided that encourage modularization of programs by the ability to nest sections of a diagram into sub blocks; the programming environment being able to do this as part of its functionality. At the basis function level, coupling between functions is limited through the object oriented aggregation of basis functions into objects, encapsulated data and improved cohesion of functions related by shared data.

Within the environment, programming interfaces specify application software integration. In addition, an execution system language interfaces the programming environment to the execution environment. The low level software modules are reusable modules that do not generally need to be specified by an application programmer and the level of the programming interface can be defined to be of a functional nature, making use of these basis functions. Functional programming is naturally intuitive in its graphical form, especially in the data flow approaches. In particular, for real-time systems, a method of extending this representation to include general control flow features provides the preferred choice, provided that it is also assessable to the intended users.

The interface between the programming environment and the operational stations is preferably simple and minimally represent the user application's specification and potentially be efficiently executable. The interface preferably allows sufficient control of the processing for concurrent real-time processing to be specified. The interface preferably allows a high degree of testability of component modules. Furthermore, the interface is preferably usable to map run-time information back to the programming interface for debugging.

As used herein, the interface will be referred to as a language. An object oriented language closely relating to data flow function blocks in their flattened form is defined. In the detail of choosing how mappings between objects are defined in the proposed language, there are a number of opportunities to be taken to carry out some simple pre-processing of the data flow diagram to move towards a language that is readily executable on a general set of different processing architectures. This language is referred to herein as “system object description language” or SODL. This language is sufficiently general to describe any computable function on a processing system that can be executed on a single processor system, a multi processor system, a distributed system or parallelised processors, such as that provided by field programmable gate array (FPGAs).

For the first of the above requirements, the application programming interface is further refined by use cases. A first is the definition of how components are integrated to form the overall system and a second is a specification of the component algorithms. Certain users, such as algorithm developers or device driver developers, benefit from an ability to provide processing component modules in a form native to the execution environment and ready to be integrated by their user base. These lower level types of user would typically be conversant with conventional procedural languages and would prefer to use these to develop fast target compatible library modules. Thus, another preferred requirement is to perform module programming and develop integration interfaces to allow implementation of software modules in third generation languages to be made available in execution environments.

To achieve portability of code written for native execution, a module-programming interface is defined to encourage the use of open standards for any input/output functionality. From an algorithm developer's point of view, the module-programming interface can be abstracted from direct interaction with third party compilers.

After the interfaces have been defined, it remains to analyse the requirements for the tools that translate between the various external interfaces and support the execution of the applications. The desirable aspects of the programming environment may be summarised as follows. The data flow-programming environment should be complete with specific functionality for time extensions. The interface should be minimally coupled to the processing system and provide compilation systems for diagrams to a functionally oriented description language. The interface should allow for the absorption of user-defined icons and function specifications from electronic meta data sources. The environment should encourage the provision of real-time concurrent processing specifications and allow the calculation and display of expected real-time performance using function specification meta data.

At a first step, some formality in the programming environment is required to ensure that the interpretation of programs is clearly unambiguous. A formal method that is closely related to the overall architecture of the system is the data flow diagram with real-time extensions. Systems specified in this environment can make discrete event handling and data flow clear in a single diagram.

The main concept here is the transformation of data and control flow specifications into a machine understandable language. This information is mainly concerned with a diagram's interactions, with some additional configuration information for each block. Each block in the diagram represents a collection of cohesive functions, that may operate on the shared state data, that persists between function calls. Cohesive functions are functions that co-operate in an interconnected but predetermined manner.

The state data and real-time specifications, that is the assignment of functions to processes in groups, suggests an object orientated framework for the generation of description software. This language, referred to as SODL, describes the data and control flow between processing objects, but not the internal functionality of the objects themselves.

The object of the SODL language design requires it to be easily parsed for the construction of a virtual machine, for subsequent execution. The environment should only require minimal interpretational functionality to establish the necessary internal state, configured to execute a user's application.

The analysis of the components necessary for a complete system development system includes the identification of extensions to the graphical programming methods currently available for specifying real-time systems and the development of a new type of execution system which is both robust and portable. The system that translates application specifications into executable systems is centred on a simple description language. The system must have the functionality to specify and efficiently execute all types of systems typical of control and communications systems such as discrete event driven and synchronous systems with real-time concurrent processing requirements.

The separation of the programming and execution environments is intended to improve the certainties with which system software can be transferred between platforms. By default, this separation also allows flexibility in the specific programming environment that a developer may wish to use.

SODL is designed so that software generated in this form is executable on any hardware platform for which the execution environment exists. Typically, the execution environment is implemented in software on general purpose computing hardware. The execution environment is a real-time virtual machine operating on largely functional code. The portability of this system is a practical issue because this could limit the number of different computing targets that a user application can run on. By implementing the virtual machine on the foundation of third party real-time operating systems, a large degree of portability can be obtained.

The SODL programming interface is course grained enough in processing units such that target processing statistics, such as CPU usage, are readily transferable to the programming environment allowing a programmer foresight in the processing requirements of the application.

The functional encapsulation of real-time algorithms, such as scheduling and inter-process message passing, allows an application programmer to specify and identify real-time requirements without implementing any scheduling algorithms, mutual exclusion, interrupt handling and other such details. This architecture also lends itself to distributed processing, where message passing can be conducted across a distributed system using real-time protocols, which again the application programmer does not need to be concerned with the details thereof.

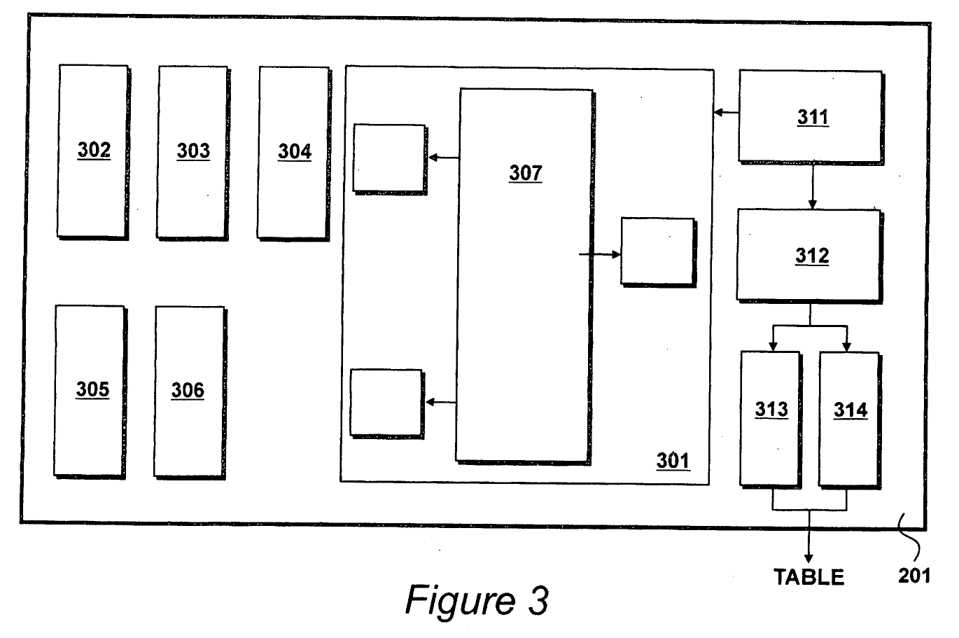

The programming environment 201 of FIG. 2 is detailed in FIG. 3. The programming environment includes a workspace 301 that is used to construct a graphical representation of a target real-time system. The graphical representation of the target real-time system is constructed using a number of sets, that include a set of basis functions 302, a set of identifiers 303, a set of groups 304, a set of events 305 and a set of data tags 306.

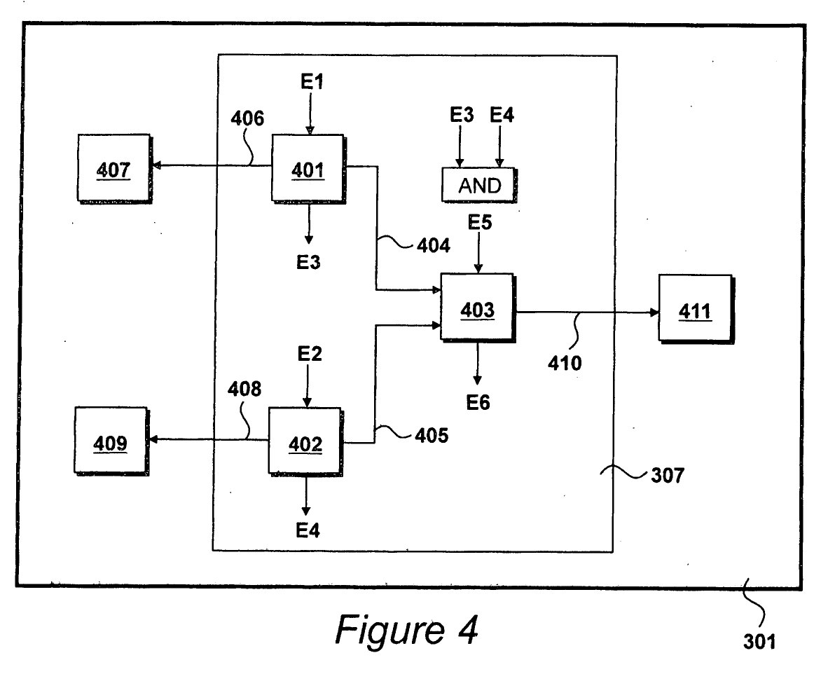

The workspace 301 has an object 307 that has been created by dragging three basis functions into the workspace 301 and linking them via a pair of input/output links, as detailed in FIG. 4.

A data flow and event flow topology processor 311 is arranged to monitor changes within the workspace 301 to ensure that all functions incorporated therein and the associated links therebetween, together with the various input and output triggers, are captured and sent to an analyser 312. The analyser 312 is arranged to establish a table of connection tags 313 furthermore, an object writer 314 co-operates with the analyser to produce a system object description table.

The workspace described contains a single object but in practice the workspace 301 could contain many objects each containing respective basis functions for performing respective operations. Furthermore, it is possible to assign one or more of the objects to an object group taken from the set of groups 303. Furthermore, the analyser 312 is arranged to produce a system object description language table for each object.

The workspace 301 is detailed in FIG. 4. Object 307 has been created by dragging three basis functions 401, 402 and 403 into the workspace and linking them via a pair of input/output links 404 and 405. A first basis function 401 is illustrated as having an associated data input link 406 representing a communication channel by which data can be received from a corresponding device 407. Similarly, the second basis function 402 is illustrated as having a respective data input link 408 representing a channel for receiving data from a second device 409. Each of the first and second basis functions 401 and 402 is connected to the third basis function 403 via two links 404 and 405. The third basis function 403 is illustrated as having the two data input links 404 and 405 as its data input channels and a single data output link 410 representing a data output channel. Thus, the data output link 410 is illustrated as outputting data to a corresponding device 411.

Each of the basis functions 401 to 403 is invoked or triggered via a respective event chosen from the set of events 304. In the example shown, the object 307 shown within the workspace 301 uses a plurality of events E1 to E8. The first basis function 401 comprises a respective input or triggering event E1 and a respective output trigger or event E3. The second basis function is illustrated as comprising a respective input trigger or event E2 and a respective output trigger or event E4. The third basis function comprises respective input and output triggers or events E5 and E6. An input event E5 for the third basis function is illustrated as being derived from the logical combination of the two events E3 and E4 using an AND operator or function.

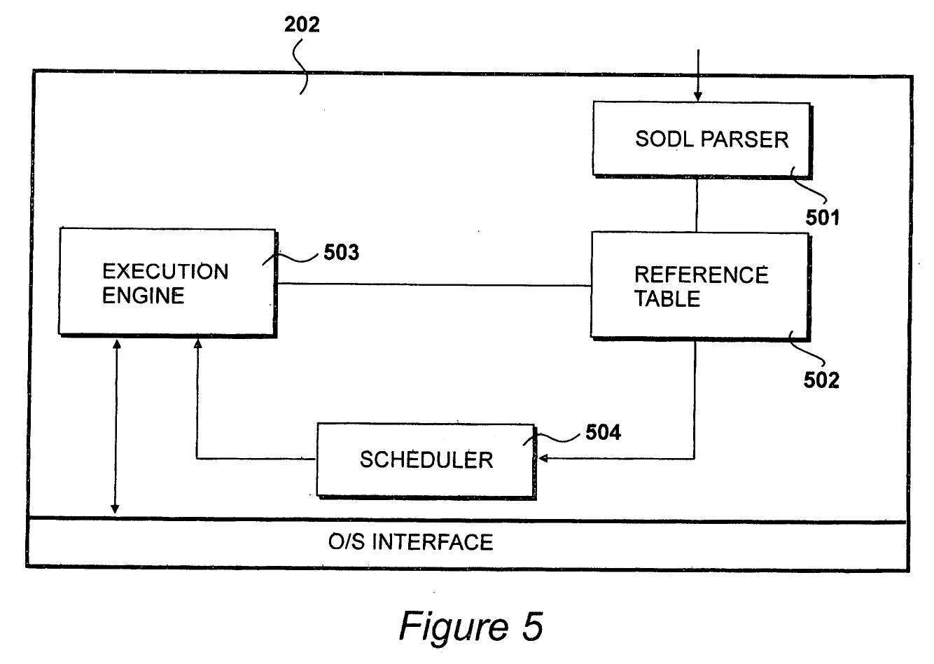

The event handler 202 is detailed in FIG. 5. The system object description language and the data table are sent to the event handler for execution. At the event handler, the language is parsed by a parser 501 to create a function and perimeter reference table 502. The event handler 202 also includes an execution engine 503 and a scheduler 504. The execution engine 503 is arranged to traverse the function and perimeter reference table 502 to give effect to the basis functions identified therein according to whether or not corresponding events have been detected.

The scheduler 504 is used to schedule any such processing of the function and parameter reference table 502. In particular, the scheduler 504 is arranged to control which group is executed by the execution engine 503 according to a predetermined scheduling algorithm. The aim of the scheduling algorithms are to manage consumption of the lower level resources such as the hardware 203, real-time operating system 204, native code 205 or BIOS 206 by the basis functions.

The application programming environment is based on data flow with real-time extensions, which allow the programming of event driven systems by the programmer specifying special control flow connections between processing objects in a similar manner to specifying data connections. The functions themselves are implemented only in the processing environment and are necessarily held in any executable form in the programming environment. The execution environment is essentially programmed as a virtual machine event handling system, which can execute functions in response to external and internal events. The virtual machine handles all of the necessary real-time scheduling and also provides storage for processing object state and inter-object data passed between processing functions. This actively controlled processing environment is referred to herein as the event handling system (EHS).

The required SODL application code is generated by a the data processing system, preferably using a CASE, now on referred to as the data event programming DEP application. SODL may be a tagged plain text format specification language, that can be stored as a standard computer file. To execute this code it must be transferred to the permanent storage of the EHS by file transfer. The target system (which is operational station 101) is pre programmed with the EHS so as to support such download operations.

The SODL is an object oriented language that describes the interdependence of a set of predefined functions using an event based framework. It is designed to be easily and unambiguously generated from CASE tools, in particular the DEP described above. The language is devoid of explicit procedural constructs and is more imperative in nature, though a sequence of computational steps is typically implied in an SODL program.

The program aims to encapsulate as much internal complexity of the users application as possible, leaving the programmer to deal with functional rather than procedural aspects of the application under development. Encapsulation of high level functionality is maintained in as many of the lower levels of software transformations as is possible. This approach influences the robustness of the development system from an application developers perspective, because the lower levels of software implementation are already achieved in the EHS.

Loop instructions or conditional branching are not build into the language that may be invoked from functions containing logic processing. The functions are more correctly referred to as methods because all functions are associated with an instance of an object. The objects may contain state information for a particular use of a function, for example a digital filter, containing the filter state, or even an entire database system may be held within an object's attributes. Objects encapsulate data for a group of methods, for example the two methods required for a stack push and pop. The structure of the internal data (attributes) is entirely hidden from the SODL and only accessed through methods.

Data typing is used for messages passed between methods. Message channels are realised as data locations in the data tables of primitive scalar data types boolean, integer and real. The language also supports arrays of these primitive types. Specific structured data objects can also be passed in a similar manner.

The executable part of the language is structured into object configurations. Each object represents a processing unit, which may have one or more functions. The set of methods associated with an object are linked to methods typically belonging to other objects via data channels and event channels.

The SODL also contains parameters that may be necessary in configuring the processing functions or device drivers. A feature of the SODL is the separation of functional parameters from specific parameters, such as GUI geometry or device driver port settings etc. System specific data is stored in separate configuration files for and the SODL file and can be distributed appropriately for each platform.

The SODL defined for this system abstracts input/output devices and algorithms as certifiable modules available to the programmer. The mechanisms for synchronisation are also abstracted in the SODL, via a process triggering framework that handles process scheduling. The interaction of processing data and synchronisation signals is completely defined by the programming environment

SODL specifies both the flattened topology of data and the control flow interactions specified in a DEP data flow diagram; and additionally communicates users parameterisation information for the processing objects. Each processing function belongs to a processing object but a diagram's topology is specified only in terms of an object's functions. This specification is implemented by the arrangement of unique identifiers to message pads between functions, instead of each function being explicitly related to other functions in the SODL. The objects themselves are represented in the SODL to identify which functions may share persistent object data. The representation of functions belonging to objects also allows configuration data to be specified for a group of cohesive functions.

Every used processing or basis function is assigned to an object and each object is of a class type. Each object may contain one or more used processing functions defined as disjoint subsets relating to each object.

The individual functions are each also associated with the topology information defining specific input and output associations between functions. Each process may be mapped to one or more other processes. This association is specified using an intermediate set of unique identifiers rather than by direct reference to functions in the set.

Every processing function is mapped on to a process group. Each task group has a one-to-one association with a portion of the processing resource and a temporal granularity value. The portion of processing resource specifies a guaranteed fraction of the processing usage, such that the totality of the portions does not exceed the total availability. For each task group, the temporal granularity specifies the maximum period between possible executions of a group. From an input/output perspective, this value governs the maximum sampling interval for processing. Processors in the group can execute any number of times within the temporal granularity as a result of events monitored in the group that need only respond to events originating from external sources once every period.

The SODL is presented here in a convenient plain text format, but could be encoded in binary or contained in more sophisticated mark up languages. SODL need not be human readable and should be handled by a machine with minimal algorithmic complexity.

Each function in SODL is assigned unique identifiers for describing the events which trigger the beginning of the function; the events to set when the function has completed; the locations of input data to read; the locations of where to write output data; and the processing group of the system.

The grouping of functions into objects requires that the name space of the functions does not contain any duplications. Each function name is unique within a class. Each object requires only its class name to be represented in the SODL; each specific instance is not uniquely labelled. Each object is attributed with specific parameters such as additional conditions and configuration information.

In addition to the topology specifications, SODL also specifies scheduling information. Thus, in summary, the SODL identifies the topology of a data flow diagram and defines the processor usage requirement for its nodes.

The specification information in SODL is restricted as far as possible to relate only to functional information; generic processing requirements of the system are specified as attributes. These parameters are intended to specify device independent information, to ensure the portability of SODL without necessarily updating the graphical software in DEP. A mechanism in creating and reading SODL to reference device specific data held in linkable device description files enables the separation of this data and for independent editing of device configuration data.

The DEP graphical tool generates the data or configuration tables and compiles the tagged information in a numerical form that can be used by the EHS directory to allocate memory to the passing of messages between processing objects. The numerical identifiers in SODL are qualified by data type, including the primitive types boolean, integer, floating point and string. Data arrays are tested as contiguous intervals in these tables and their size is identified by a quantifier appended to the data type identifier.

Specialised data types may be included by extending the type identification labels identified in the SODL. The DEP tool generates SODL, including the tagged topology information.

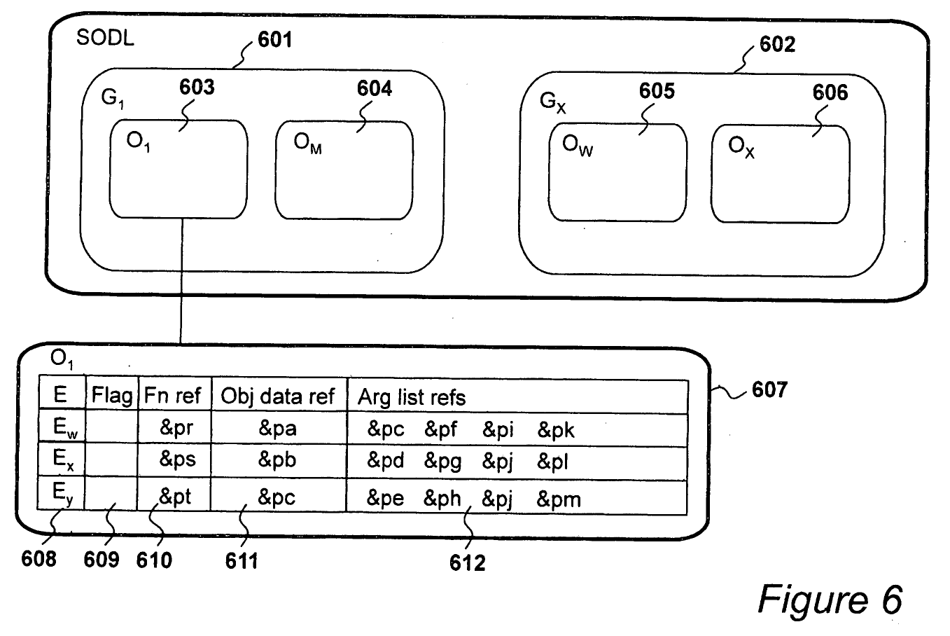

Data structures are illustrated in FIG. 6, including a system object description table. The system object description language table is illustrated as groups 601 and 602. The first group 601 contains objects 603 and 604 and the second group 602 is illustrated as having objects 605 and 606.

Each object has an associated table and an example of the system object description language table 607 for the first object 603 is shown in FIG. 6. The table 607 has an event column 608, a flag column 609, a function reference column 610, an object data reference column 611 and an argument list column 612. The event column 608 contains tags EW, EX and EY corresponding to the events that trigger the basis function whose reference or address is contained within the function reference column 610. The flag column 609 is used to provide an indication as to whether or not a corresponding event has been triggered.

As previously indicated, the function reference column 310 provides a reference to, or an address via which, a corresponding basis function may be accessed. The object data reference column 611 is used to provide an access mechanism for internal data corresponding to an object. The argument list reference column 612 is used to provide arguments or, more accurately, addresses for arguments.

Processing control flow is identified by the SODL tag identifiers that describe the control topology of the DEP diagram. These tags identify events within the system that instigate processes. Events are generated in the system on the completion of a processing task and typically signal that new data is available for subsequent processing. Input device processes generate events after external stimuli and signal the presence of new information using the event structure.

The EHS is largely concerned with configuring a processing system (microcontrollers, microprocessors or digital signal processors etc) to call processing functions with real-time synchronisation. The event driven system is based on a simple active function calling algorithm, sequencing functions as specified in the SODL. This active function calling mechanism enables different process scheduling schemes to be adopted depending on the type of processing required and the required time constraints of the application. A subset of processors may be scheduled co-operatively and the remainder pre-emptively. EHS may make use of RTOSs to implement the lower levels of pre-emptive scheduling algorithms.

The implementation of the EHS is layered from a hardware independent software layer to the hardware itself. The interface between these layers would typically involve a COTS RTOS. The software layers are structured so that where an RTOS is not available for a hardware target, unnecessary porting is a more simplified process of implementing a software layer that reproduces the necessary subset of the POSIX operating system. The highest level scheduling scheme is resource reservation under which other schemes are subordinate.

The uppermost EHS software layer contains the core algorithm that initiates or schedules processes to run at the required moments. Below this algorithm lies the RTOS functionality. For many target hardware platforms, this functionality can be provided by third party operating systems, ideally of a standardised form such as being POSIX compliant, to at least increase and preferably maximise the portability of the EHS to other platforms. For hardware, where no such OS exists, only a small subset of the functionality of the POSIX OS functionality is required by EHS.

The EHS system layer need not be implemented using standard computer architectures and, for example FPGAs also provide an effective hardware type with the added value of allowing simultaneous parallel processing.

For real-time systems typical of embedded systems, application programmers require explicit visibility and also control of a processing application's control flow. Embodiments of the present invention provide an extension to real-time data flow representations to provide the generalised programming environment able to specify scheduling while remaining uncomplex.

The most demanding of real-time programming is for discreet event driven systems and, because sampled continuous data flow models can be viewed as a special case of this type of system, only one domain for the extended flow diagram is necessary. The preferred programming environment to produce SODL is the extended data-flow representation. Such programming and such a programming environment will be referred to herein as Data Event Programming (DEP) and a DEP environment. Embodiments of DEP aim to have a simple well understood formal basis for specifying real-time applications.

An extension of this approach over conventional data flow diagrams is the inclusion of control flow connections between processing entities. Control flow is modelled strictly as momentary triggering events. Within embodiments of the present invention, momentary triggering events are defined as arbitrarily timed events during the EHS execution which can be generated by processing functions including, for example, input devices, timers and data processing functions.

Events are typically generated by the EHS and signal the availability of a processing result and may be conditional on the results of processing. Events in the EHS are not typically caused by system interrupt events unless the processing function associated with an input device is triggered by such a method. Continuous control flow is modelled by periodic event triggers. The new dimension added to the data flow representation explicitly specifies the synchronisation of data processing. The complexity of the diagram can be reduced in most cases because control flow topology will be very similar to data flow, particularly for signal processing and continuous control applications. Under these circumstances, the control arcs of the diagram may be implicitly overlaid or visually associated with data arcs.

Data processing blocks are directly related to a number of processes on a virtual machine. Each data block may have one or more data inputs (scalar or vector) and data inputs are similarly represented. No two outputs are permitted to be connected together to the same input. Connection rules in DEP test for this so as to prevent the generation of incorrect SODL. These tests prevent the so-called racing conditions that may occur in data flow diagrams.

In addition to the data connections, each function in a processing block has a trigger input to receive trigger event signals which typically instruct the process to read its input data and begin execution. Completion of tasks is indicated by outputting signals from the processing block. The interconnection of these events specifies the control flow of the application. Each processing icon therefore has two main categories of ports, one defining the data dependencies and the second defining the synchronisation of processing procedures.

The Semantics of the diagram can be graphically interpreted as events emanating from a function block event output ports and causing any number of subsequent processing blocks to fire. The data connections are interpreted as holding data generated by a processing function from its last activity.

Typically, events are produced when some data is ready to be processed and, as such, the connection of events often follows data connection paths. The possibility for separating event connections and data connections allows explicit specification of control flow. Manipulation of control flow can be carried out using specialised icons with only event ports which can carry out logical functions of event signals. The logical functions are token-based and the functionality of many token-based synchronisation schemes may be implemented with such icons, including time threads for example.

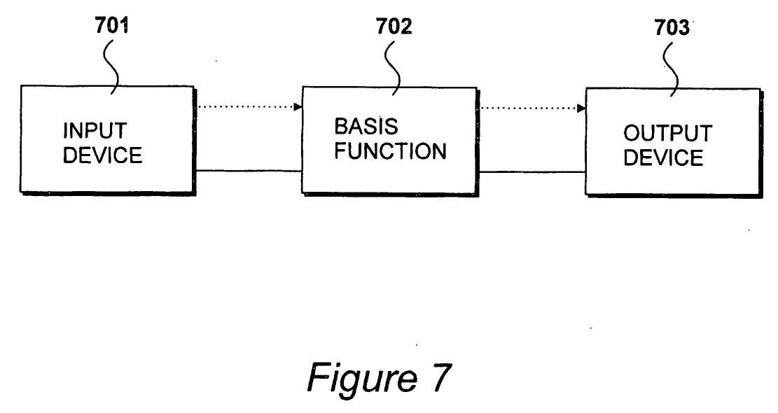

An example of a single processing system is shown in FIG. 7, comprising an input device 701, a processing function 702 such as one of the above described basis functions and an output device 703. The input device 701 passes data to the processing function 702 which, when finished processing, passes the result to the output device 703.

In embodiments, the internal implementation of the blocks may be considered as built-in processing functions. This type of block is used by the programmer without consideration of the internal algorithm.

There are certain properties of the processing function that are usefully incorporated into the programming environment In particular, the worst case execution time (WCET) is a useful statistic associated with the particular implementation of a processing function that can be used for planning and scheduling an estimating temporal performance in the DEP environment. There may also be adjustable parameters for a processing block that can be specified by the programmer.

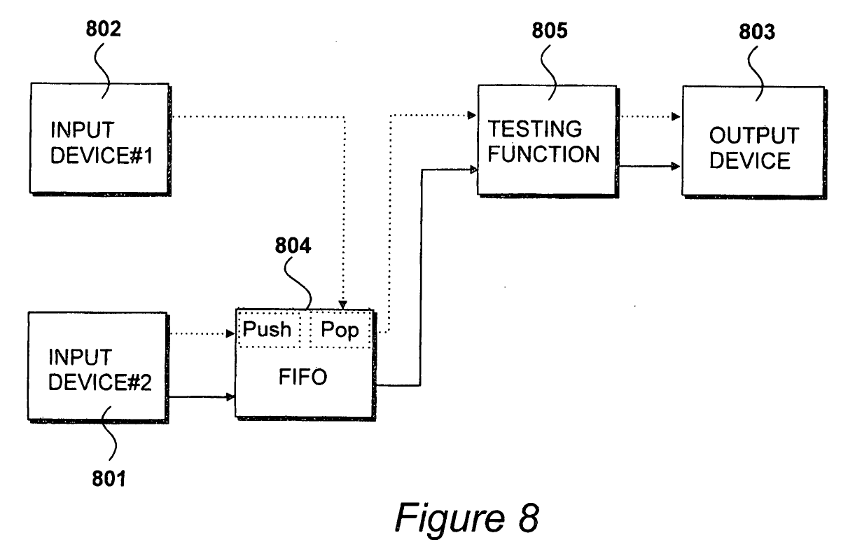

An example of a more complex object is illustrated in FIG. 8. The object of FIG. 8 extends the two input system to facilitate the handling of synchronous data streams. An application of this nature may arise when randomly spaced articles are moving through a manufacturing facility in a fixed order, where they are measured by an input device 801 and their presence is detected at some time later by an input device 802. Input device 802 and output device 803 are associated with a reject station and the objective of the system is to use the previous asynchronous measurements to identify substandard articles and to remove them using an actuator controlled by the output device 803.

The application shown in FIG. 8 requires memory which is provided by the provision of a first-in-first-out (FIFO) buffer 804. As articles are measured, the information is stored in the FIFO 804 by clocking in the data using the event signals. When articles reach the reject station, its presence clocks out the measured data associated with it, which is tested by the processing function 805 and the output device operated accordingly if the article is to be rejected.

The application introduces a new type of processing object because the FIFO is different to the other processing function (test function) in that it has two event input ports, one used for clocking in and the other used for clocking out. This implies that the fifo object has two functions associated with it. The fifo buffer also has an internal state that must be maintained inbetween function calls and shared by functions associated with the icon. Many types of processing blocks require persistent state information, such as processing filters.

DEPs allow for a high degree of data and synchronisation consistency checking during the programming stage. The interlocking of processing with specific data travelling through the system is readily testable in the development environment for inconsistencies, such as ambiguous specification of synchronisation leading for example to race conditions.

For specifying the schedule priorities of functions in processing blocks, each function in a DEP diagram is assigned to a notional group of processing. Each processing group is reserved for a user-specified allocation of processor resource and frequency with which the resources are made available. Depending on these values and using knowledge of the WCET of the processing functions, each group may be configured to deliver different types of real-time performance. For example, a group where the total WCET is less than or equal to the allocation of resources and where its repetition rate is less that the groups frequency will struggle to provide real-time performance. However, where the WCET is larger than the resource allocated, quality of service may be guaranteed. Some groups may be allocated zero resources in which case they will run as prioritised background tasks.

DEP is compiled to the SODL once all processing objects are defined in terms of the in-built basis objects. The compilation simply involves the allocation of unique identifiers to all the icon interconnects and the mapping of function arguments to these identifiers. The scheduling and grouping of information is also recorded in the SODL file.

DEP also supports the case tools expected of a data flow diagram. For bottom-up development, the encapsulation of related processing blocks into group icons allows initial structuring and this structuring can be practised using generic empty blocks.

The close relationship of DEP representation with the SODL allows run time information from the EHS environment to be relayed back to the DEP environment by the mappings contained in SODL. The information may be offline statistical information to help optimise the system process grouping design and also to inspect actual usage information gathered during EHS execution. Real-time information may also be relayed back, such as function processing status and data line values.

The event handling system is arranged to carry out processing tasks in synchronism with events caused by either external entities or entities such as basis functions within the EHS. The EHS contains the necessary structure for processing tasks to communicate variable data between tasks and also for specifying which tasks should follow in execution. The structure is parameterised by the information in SODL. The EHS includes the active management of task execution and data passing, thereby freeing up the processing tasks themselves from this duty.

The event handling system may be implemented in hardware or software. Primarily, the EHS is a specialised real-time operating system for executing processing functions with reference to variable data that is maintained by the operating system. Each function's reference to the data and the sequencing of its execution is specified in the SODL. Execution sequence is specified by a set of event relationships between functions, some of which may be the result of an external event detected by 10 processors and other are internal events generated by tasks as stages of processing that have been completed or as time has elapsed.

The basis processing functions supported by the EHS may be either of a low or a high internal complexity and processing duration. Examples include the primitive stateless mathematical functions such as addition to singe processing operations such as filters, and fast Fourier transforms etc. The basis functions are built into the EHS system itself or can be implemented by a user and installed in the EHS. These functions may then be referenced in DEP to incorporate them into applications.

It is known that efficiency issues are associated with the scheduling of tasks. For example, sharing a processor between tasks may require the processor to save its internal state when context switching between processes. An optimum method of scheduling is therefore not only prescribed by application requirements but also by the efficiency with which tasks can be scheduled. Process scheduling, handled by the scheduler 504 can also be grouped into two main categories, namely co-operative scheduling and pre-emptive scheduling.

Co-operative scheduling allows each process to complete fully before another is started and pre-emptive scheduling allows tasks to be de-scheduled at any moment in time for higher priority tasks to execute. Task pre-emption is a costly activity in terms of the necessary processor clock cycles required. Consequently, where possible, EHS uses co-operative scheduling to at least reduce frequent context switching.

Resource reservation is the top level scheduling scheme used in the EHS. The approach used in the EHS allows many processing functions to be assigned to an effective thread of processing but also provides robust measures to ensure minimal disturbance to independent real-time processing threads when expected processing demands are exceeded.

Each processing operation or basis function is assigned to a processing group. Each of these levels is assigned a guaranteed portion of the processor time and a preferred or predetermined preferably minimum processing periodicity. For a hard real-time task, processed time will typically be specified to account for the worst curse execution time for the processors assigned to the group. Processing periodicity can be considered as the overall deadline for processors within the group and it specifies the minimum temporal granularity of the group. Each group may then be scheduled with appropriate schemes, such as time slicing or priority based methods. The overriding resource reservation approach ensures that some tasks can be guaranteed a quality of service along side the hard real-time tasks. In addition, the resource allocation approach can guard against the proliferation of processing errors caused by unexpected processing demands in one group affecting the processing in another. Such resource containment resources increase fault tolerance for mission critical applications.

A tasks scheduling algorithm implemented by the scheduler 504 within the EHS 202 is preferably a hybrid of co-operative scheduling and pre-emptive scheduling and operates at two levels of scheduling. The finer grained level deals with processes within one group. At this level each task is executed either as a blocking task or as a threaded task depending on what is more efficient rather than what is more important. The courser grained scheduling of groups is comparatively scheduled using a suitable method. The EHS actively presides over all processes, however small,. in a framework that allows different processing modes for each process and also groups of processors to ensure processing requirements are provided for each group.

A further feature of the EHS scheduler 504 is its ability to change processing group reservations on the fly by programme specified control. This dynamic control of resource allocation allows applications to change contexts when different processing activities occur, such as a change of operating mode or even an emergency situation where some groups must be maintained but others may be abandoned.

The virtual machine environment is based on an active processing algorithm for detecting events for executing data flow processes and providing data message paths between functions. Process sequencing performs an algorithmically simple function for calling procedures and for identifying input and output data. Much of the information for specifying process sequencing and identifying variable data is pre-prepared from the information held in the SODL. Message paths and the association of events with functions specified in the SODL are initialised into machine memory so that the active run time algorithm is not required to interpret each function but simply calls it with the required data.

Processes are treated generically, having standardised entry, exit and data passing interfaces. The system effectively behaves as an interrupt event driven system, where events are associated with functions. The EHS 202 builds the necessary framework for variable data and internally generated events to be handled in an event triggered fashion but using time triggered algorithms rather than the direct handling of interrupts.

The essence of the processing events sequencing algorithm is simply to test for events and trigger processes on these events which when complete define the next set of events to enable the processing sequence to continue.

A set of event flags forms a notional event register table with elements. Each event is associated with the completion of a process forming a many to one mapping for the setting of the flags. Each event is associated (by SODL) to a set of processing or basis functions which are directly dependent on the event. These dependent processes are defined by mappings. If each function has only one completion point, each process can be directly related to only a single event which can trigger a set of functions simultaneously.

An equivalent formulation for multi-stage processing may be used where each process may simultaneously trigger a set of events, each of which is associated with just one processing function. In such embodiments, instead of each function asserting a single event for each of its completion events, an equivalent formulation allows each completion to have directly set a number of events associated with subsequent processing. A set of event flags forms a notional event register table with elements. Each event is associated with a single processing function resulting in a set of one of more mappings. When a process has completed, a set of events are triggered defined by a one to many mapping.

A topology of data connections is similarly specified by a space of identifiers synonymous with a variable data space. Processes can operate on this data space. An element can be read by multiple processes but written by only one. This allows unambiguous specification of data flow. Each process may have more than one independent input variable. Each process may also have more that one dependent output variable. All processing functions associated with an object may share data allowing data path through function blocks to cross between functions.

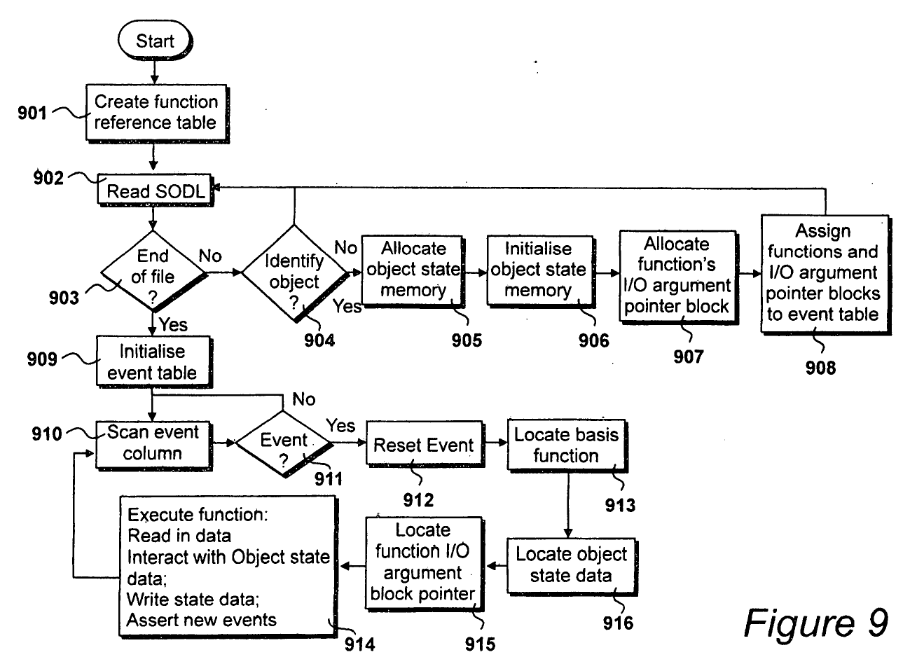

A flow chart of the processing undertaken by an embodiment of the event handling system 202 is shown in FIG. 9. At step 901 a function reference table is created. An object is read from the SODL table at step 902. A determination is made at step 903 as to whether or not the end of the SODL table has been reached. If the determination at step 903 is negative, an objects class name is read from the SODL.

A corresponding identify function is called at step 904 that provides the EHS with information such as how much memory is required to accommodate the object if the read object is an identify object. If necessary, memory is allocated to retain object state data at step 905.

The allocated memory is initialised at step 906 by an initialisation function, corresponding to the class. At step 907 an input/output argument pointer block is allocated. Addresses are assigned to input/output data pointers in the initialise function input/output argument pointer block at step 908. Thereafter, processing resumes at step 902.

If the determination at step 903 is positive, a scan is instigated at step 910 to determine, at step 911, whether or not an event or flag has been set. If the determination at step 911 is negative, processing resumes at step 910. If the determination at step 911 is positive, the event or flag is determined to have been set is reset at step 912.

The basis function corresponding to the set flag or, more particularly, the address for the basis function, is extracted from the event table at step 913. At step 916, the object state data corresponding to the identfied basis function is located, using the object data also referenced in the event table.

The address of the function input/output argument block is extracted from the table at step 915 and the basis function is executed at step 914 using the information identified from steps 913 to 915. Thereafter, processing resumes at step 910 in anticipation of the executed function having output events or triggers and, in turn, causes a change in the flags of the SODL table.

Within each embodiment, the processing of a basis function is a direct formulation for each event.

Computations often require some kind of recursive and conditional processing to be performed. There are two modes of suitable storage available in the EHS for recursive calculations. One is the data space and the second is the persistent data shared in objects. Scale elements are not randomly accessible in the EHS (which executes the static data flow diagram) however processes may randomly access elements within an array, provided a method for scaling elements of an array is available.

Alternatively, random access to the data can be provided by an array storage function that allows the reading and writing of its internal data conditioned by location information. Either of these approaches are possible for constructing algorithms but in general this procedural approach is not necessary or desirable for functional programming at the systems integration level.

Data stored in the EHS is separated into the inner object message data and the intra-object data stored in objects. The data space is used to pass data between functions of different classes in a similar manner to register based processing machines. Persistent intra-object data is associated with objects and allows state data to be stored between calls to functions and also shared between functions of the same class. The processes act on input data and possibly internal state data and produce output data. The data is stored in tables where it can be numerically indexed. Each element of the table can be viewed as holding messages passed between processes.

The mechanism for message passing is that on execution of a process the process reads by reference to its location which is numerically specified in the SODL, defining the mapping. On completion, the process writes its outputs to the positions in the data tables specified in the SODL. The output data is then available for any subsequent processing functions to use. These data channels, buffered in memory by the data tables, are synonymous with data arcs in the data flow diagram. These channels remain statically assigned to processing functions as expected for a static data flow diagram.

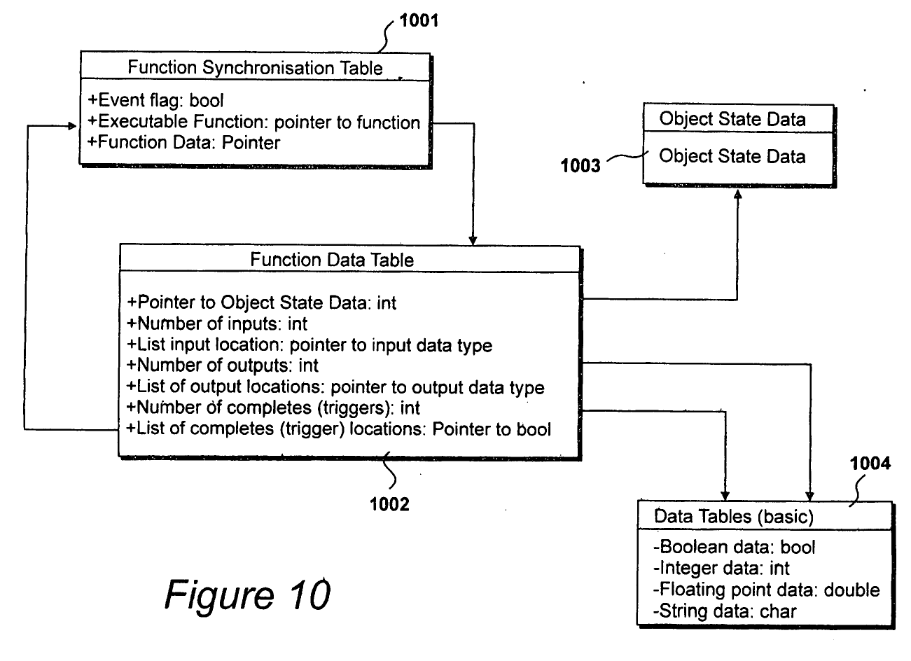

An example of the arrangement of data tables illustrated in FIG. 10. A function synchronisation table 1001 corresponds to the SODL table. However, the data illustrated within the function synchronisation table shows a single basis function. The function synchronisation table 1001 shows an event flag having a Rouen type, appointed to an executable basis function and a pointer to the processed data using the basis function. The pointer is used to access a function data table 1002, that contains data for accessing the data to be processed by the basis function. The function data table 1002 comprises a pointer to the object having an integer type that locates and affords access to the object state data contained within an object state data table 1003.

The function data table 1002 comprises an integer type representing the number of inputs to the corresponding basis function. The location of the list of input data values having a corresponding input data type is also included in the function data table 1002. The list of output locations, that is, locations which output data produced by the basis function should be written, is identified using a pointer having a corresponding output data type. The number of output figures associated with the basis function is determined from an integer.

The scheduling schemes in the event handling system 202 may be broken down into three levels, starting from the coarsest grained control to the finer grained processing. These therefore may be considered as resource reservation, task prioritisation and process scheduling.

Resource reservation is concerned with guaranteeing processor utility for tasks and coincidentally also provides an application developer with an intuitive method for specifying real-time requirements without requiring specific scheduling information such as prioritisation to be calculated. Resource reservation also provides a means for quality of service metrics to be specified for soft real-time processing, that cannot be specified in a priority only based model. Resources can be reserved at the granularity of the processing groups that can be though of as threads in a concurrent processing scheme. Task prioritisation is not explicitly specified by an application developer when specifying task resources but a choice of task scheduling schemes can be made available.

A number of scheduling algorithms can be applied within the resource reservation framework including rate monotonic (RM) deadline monotonic (DM) or earliest deadline first (EDF) scheduling schemes, as are known for use in real-time systems. Such schemes are however oriented to interrupt driven processing where each task is assumed to be largely independent and is executed as a contiguous block until the readiness of a higher priority task. Where tasks have a high degree of independence on other tasks the theoretical advantages of these algorithms is compromised by priority inversion or deadlock problems associated with the priority based block processing.

Where processing functions interact with processes in other groups, time sliced scheduling schemes may be preferred such as minimal time slicing. The EHS system operates at a finer level of processing than the task group level, dealing individually with processors. This provides opportunities for time slice processing to be achieved more efficiently than pre-emptive time slicing by interleaving complete processes without the processor overheads of context switching and mutual exclusion. The synchronisation of interaction between processes allows each group to effectively run in parallel and share intermediate data results immediately as they become available.

Whichever algorithms are used, all are constrained at run time by resource reservation parameters specified by the programmer to ensure that rogue processing (unexpected increases in processor utility) in one task group does not affect others. It also allows for tasks which are important but not real-time constrained to be guaranteed a portion of the processor usage, thus maintaining quality of service without disrupting hard real-time processing groups. Resource reservation using time slicing can allow processes to run in parallel and still meet deadlines by ensuring that the allocated processing resources are apportioned rather than prioritised to meet the necessary deadline.

Process scheduling refers to the methods with which each process in a task is executed. Processes running within a task group are not necessarily combined into a single processing thread and executed as one contiguous process in fixed sequence. Processes may be scheduled co-operatively if they are sufficiently short compared to the fastest latencies allowed in the system. The EHS may pre-empt any type of process if necessary to ensure resources reserved for any other processing group. This prevents overrunning processing groups from compromising other processing groups.

The choice of prioritisation base scheduling algorithms may be based on efficiency or safety critical constraints. For example, RM priority scheduling sometimes implies a sub-optimal utilisation factor for hard real-time tasks but is a simple and robust fixed priority algorithm favoured for mission critical applications. The sub-optimal utility figure may be acceptable if there are background tasks to be performed. Alternatively, EDF dynamic scheduling may be used if full utilisation of processing resources is required for real-time tasks. For practical reasons, dynamic scheduling is typically less robust that the static scheduling schemes. Time slicing algorithms allow a more fluid execution of processing tasks but are typically inefficient with processing resources for the frequently required context switches and mutual exclusion of shared memory. Any of these prioritisation schemes are, however, subordinate to resource reservation control which ensures that processing requirements are available for any type of scheduling.

Each group may be executed in round robin fashion but each can be pre-empted if necessary to interleave other processes in other groups. Such group pre-emption is necessary if an earlier deadline task is asserted in EDF scheduling. This pre-emption, in certain cases, does not require processor context switching. For example, a group which consists entirely of small co-operatively schedule processes can be temporarily halted and a new task group started by simply ceasing to scan group event flag tables and to begin scanning other groups. The time taken for this transition is limited by the maximum duration of any process in the group. A watchdog timer can also be used such that pre-emption is carried out in a certain time period as a last resort switch of resources.

Scheduling within a group can be implemented as a mixture of co-operative block functions and threaded processes to allow for concurrent processing within a group. Long running task can be pre-empted by the resource reservations watchdog timer mechanism which detects some functions that are about to exceed their allocation. Exceeding the processing allocation is not necessarily an error condition and this may be planned for processing groups with deadlines longer than the groups time period.

Processing efficiency should be considered because many of the processing functions will be trivial operations and any unnecessary switching overheads should be avoided. Co-operative scheduling reduces the need for context switching and mutual exclusion processing which is required for processing tasks as indivisible monolithic tasks. By guaranteeing a minimum share of the processing time and temporal granularity for each group and by knowing the worst case execution time of processes, specific schedule ability can be calculated for processing groups at the programming stage, which accounts for specific dependencies between tasks. The division of processing tasks to run as co-operatively scheduled sections, actively managed by the EHS, removes much of the need for mutual exclusion and the associated problems of priority inversion for communicating data between processes because shared resources are actively read and written synchronously in the EHS.

The resource reservation framework allows traditional real-time scheduling strategies to be moderated to merge with additional processing requirements such as quality of service. Each processing group effectively runs in a separate space, which may be implemented on a unique processor system. Processing routes may also be enabled and disabled at run time to allow different operating modes of the application.

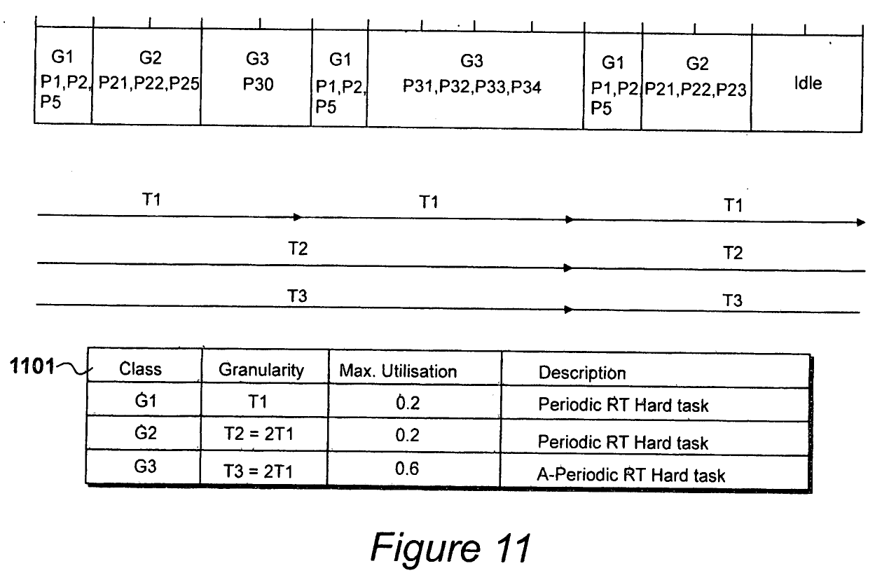

A scheduling scheme is illustrated in FIG. 11 in which there is co-operative scheduling of short processing tasks and all tasks are hard real-time. It can be appreciated that a processor allocation table 1101 indicates that group 1 tasks, P1, P2 and P5, which are periodic real-time hard tasks, are scheduled such that twenty percent of the hardware resources, such as a processor, are available over a predetermined unit of time T1.

Group 2 tasks, P21, P22 and P25, which are also periodic real-time hard tasks, are scheduled such that twenty percent of the hardware resource are made available over a corresponding period. Group 3 tasks, P30 which is an aperiodic real-time hard tasks, are scheduled such that sixty percent of the hardware resources are made available.

A scheduling scheme is illustrated in FIG. 11, in which there is co-operative scheduling of short processing tasks and all tasks are processed in hard real-time. A processor allocation table 1101 indicates that group 1 tasks P1, P2 and P5, that are periodic real-time hard tasks, are scheduled such that twenty percent of the hardware resources are available over a predetermined unit of time T1. Group 2 tasks, P21, P22 and P25, are also periodic real-time hard tasks and are scheduled such that twenty percent of the hardware resources are made available over a corresponding time period. Group 3 tasks, P30, is an aperiodic real-time hard task and scheduled such that sixty percent of the hardware resources are made available over a period T3.

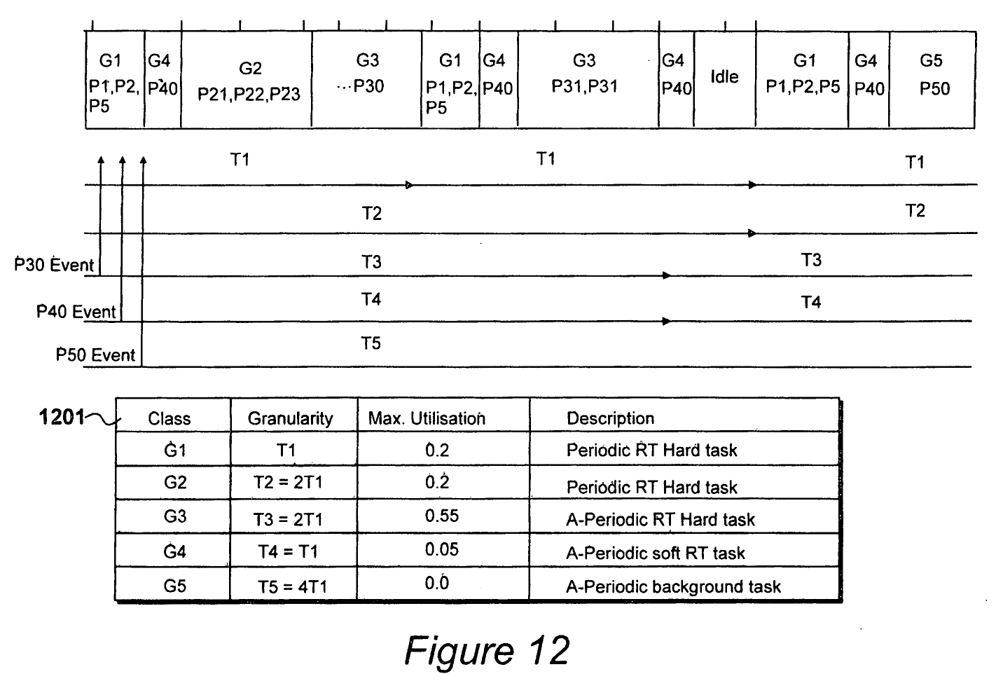

A scheduling scheme is shown in FIG. 12 in which there is co-operative scheduling of short processing tasks that are a combination of hard real-time, soft real-time and background tasks. A processor allocation table 1201 indicates that Group 1 tasks, P1, P2 and P5, which are periodic real-time hard tasks, are scheduled such that twenty percent of the hardware resources are available over a predetermined unit of time T1. Group 2 tasks, P21, P22 and P25, that are also periodic real-time hard tasks, are scheduled such that twenty percent of the hardware resources are made available over a corresponding time period T2. Group 3 tasks, P31, P32, which are aperiodic real-time hard tasks, are scheduled such the fifty-five percent of the hardware resources are made available over a period T3. Group 4 tasks, P41, that are aperiodic real-time soft tasks are scheduled such that five percent of the hardware resources are made available over the corresponding time period of T4. Group 5 tasks, P50 that are aperiodic background tasks are scheduled whenever the hardware resources are not being used by the tasks of one of the other groups.

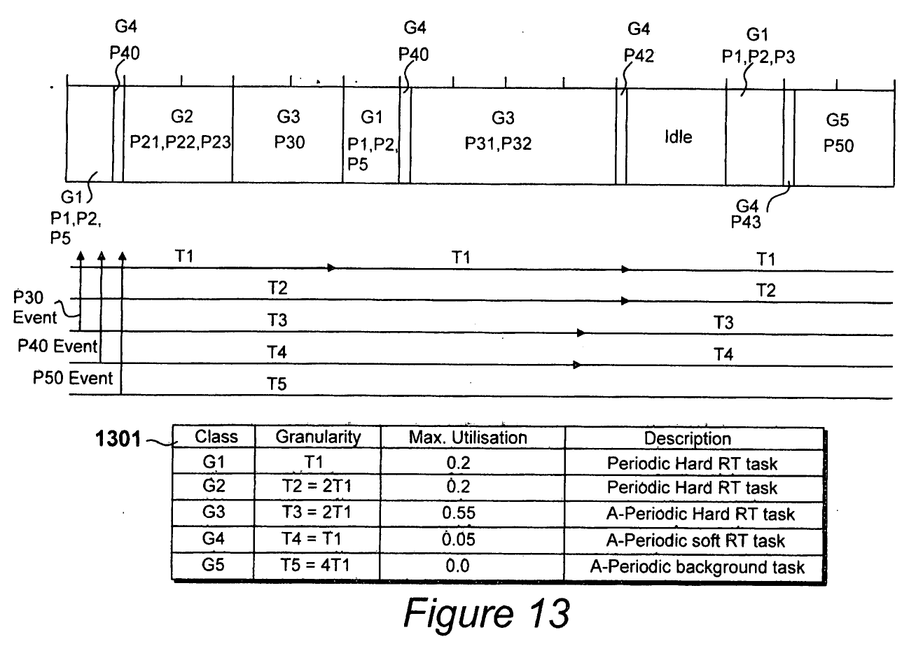

The scheduling scheme is shown in FIG. 13 in which there is a mixture of co-operative scheduling and pre-emptive scheduling of short processing tasks that are a combination of hard real-time, soft real-time and background tasks. A processor allocation table 1301 indicates that Group 1 tasks, P1, P2 and P5, that are periodic real-time hard tasks, are scheduled such that twenty percent of the hardware resources are available over a predetermined unit of time T1. Group 2 tasks, P21, P22 and P25, that are also periodic real-time hard tasks, are scheduled such that twenty percent of the hardware resources are made available over a corresponding time period T2. Group 3 tasks, P30, that is an aperiodic real-time hard task, is scheduled such that fifty-five percent of the hardware resources are made available over a period T3, this being twice the value of T1. Group 4 tasks, P41, which are aperiodic real-time soft tasks are scheduled such that five percent of the hardware resources are made available over a corresponding time period T4, equal to T1. Group 5 tasks, P50, that are periodic real-time hard tasks, are scheduled whenever the hardware resources are not being used by the tasks of one of the other Groups.

Each process is assigned as being either atomic or concurrent as part of its specification. This choice of assignment is dependent on the processor's worse case execution time. An example criterion for this classification is to assign processes with execution times smaller than the context switch time of the processor as atomic processes and others as being concurrent. This assignment is known by the EHS, that schedules processes accordingly.

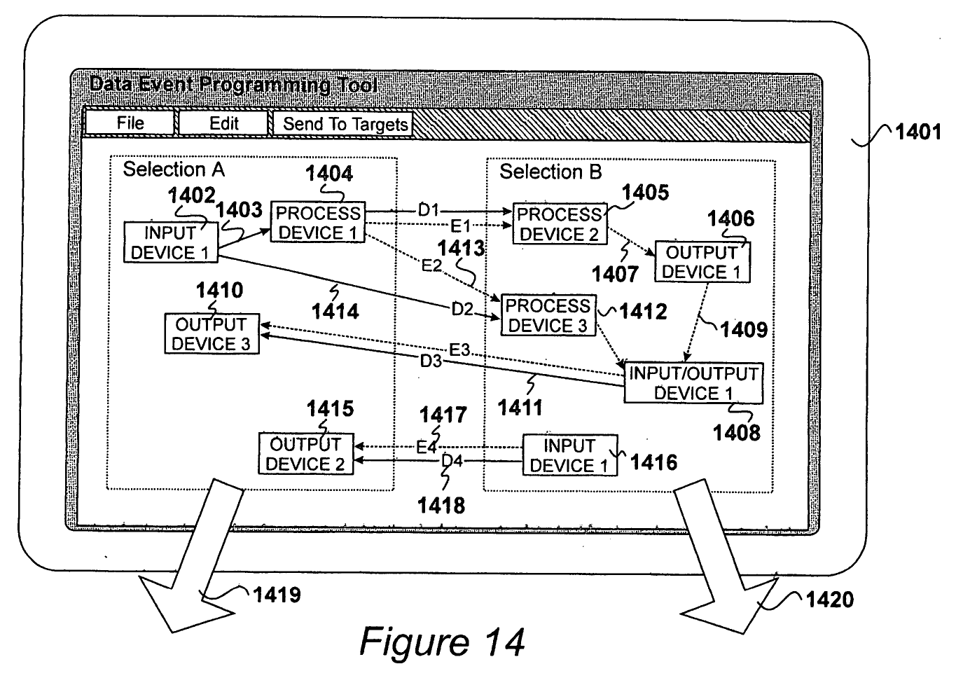

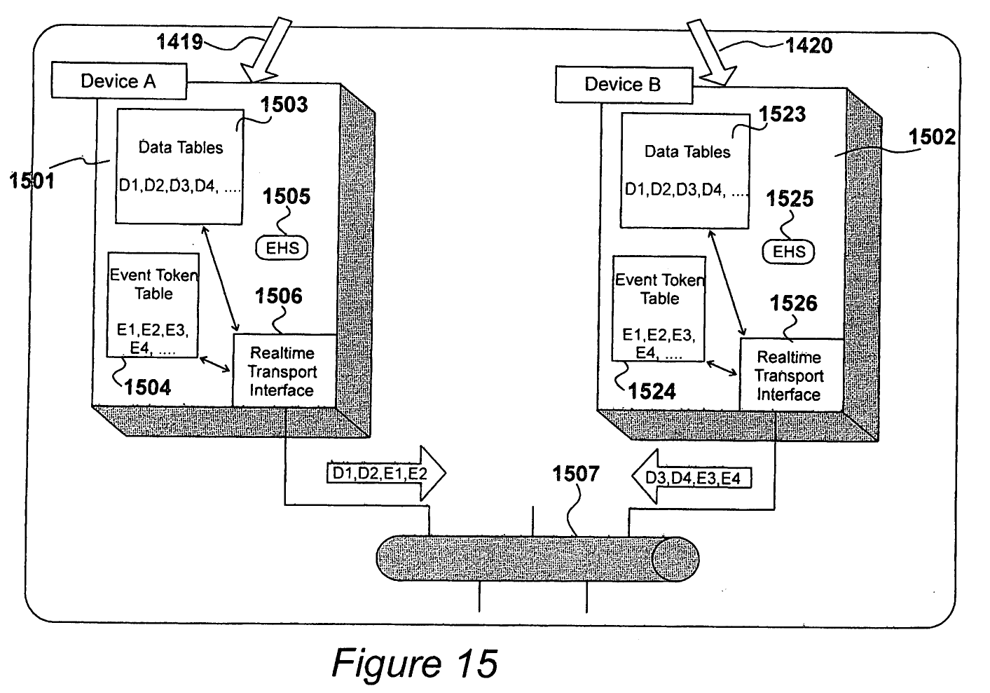

An embodiment of a programming environment is illustrated in FIG. 14 and an embodiment of the event handling system or processing environment is shown in FIG. 15.

In the programming environment 1401, a program can be partitioned by grouping icons into disjoint sets. In the illustrated embodiment, the icons are separated by two rectangular boxes marked selection A and selection B. A plurality of data and event links are provided, identified as labels D1, D2, D3 and D4 for links corresponding to data communication and labelled E1, E2, E3 and E4 for links corresponding to event communications.

A first icon, selection A, consists of representations of a first input device 1402, that interacts via a pair of data and event links 1403 with a first process device 1404. The first process device 1404 interacts with a process device 1405 via a data link D1 and an event link E1. The process device 1405 interacts with a first output device 1406 via an event link 1407. The output device 1406 interacts with a first input/output device 1408 via a corresponding event link 1409. The input/output device 1408 interacts with a second output device 1410 via an event link/data link pair 1411. The first process device 1404 and the first input device 1402 also interact with a further process device 1412 via an event link 1413 and a data link 1414. The third process device 1412 also interacts with input/output device 1408. A further output device 1415 of selection A interacts with an input device 1416 of selection B via an event link 1417 and a data link 1418.

A first version SODL data structures 1419 is generated for a first device 1501 and a second SODL data structure 1420 is generated for a second device 1502. The SODL structure 1419 for the first device 1501 will contain only objects defined in selection A. The second SODL structure 1420 for the second device 1502 will contain only objects defined in selection B.

The identifiers D1 to D4 and E1 to E4 are listed by the programming environment in the SODL structures as data that needs to be exchanged with another EHS running on another specific device. In this case, the SODL structure 1419 for the first device 1501 will reference D1, D2, E1 and E2 and specify that these data are to be transmitted to the second device 1502. The first SODL structure 1419 will also specify that D3, D4, E3 and E4 will be received from the second device 1502. The shared data specification in the SODL structure 1420 for the second device 1502 will contain information complementary to that contained in the first SODL structure 1419. This example can be generalised for any number of disjoint partitions for any number of target devices.

The first device 1501 has a data table 1503 for storing the data to be exchanged with other entities such as the second device 1502. A first device also contains an event table 1504 comprising state data, that is event data and an event handling system 1505. The data and event links or interactions are realised or supported using a real-time transport interface 1506 and a real-time network 1507.

Similarly, the second device 1502 has a data table 1523 for storing the data to be exchanged with other entities such as the first device 1501. It also contains an event table 1524 having state data (that is event data) and an event handling system 1525. The data and event links or interactions are realised or supported using a real-time transport interface 1526 and the real-time network 1507.

The EHS 1505 and the EJS 1525 are configured using the SODL files 1419 and 1420 respectively. The EHS systems operate in the normal way as for single processor operation. However, embodiments can be realised with extensions that relate to periodicity.

Periodically, the shared data identified in the SODL structures are transmitted and received using a data transport subsystem such as a field bus network, that is an embodiment of a real-time network 1507. This data are read and written to the data and event tables by the EHS at convenient moments in the EHS execution. The EHS otherwise operates in a manner substantially similar as that for a stand alone EHS.

The periodicity with which data is transferred across the network is dependent on the speed of the network, the amount of data and the periodicity of the processing functions generating the shared data. Typically, this period will be as fast as practically possible and all data that are communicated are transferred at every time period. This approach may be wasteful of network bandwidth if much of the data is infrequently updated by the processing functions compared to the period of the transfer. Therefore for complex systems where this approach may overload the network, there are a number of optimisations that can be adopted. One opbmisation is that only data which has changed in value are transmitted. The second approach is to synchronise the periodicity of the data transfer with the period of the processing functions that create the data. The latency of the network will limit which objects can be distributed across the system if the required periodicity is similar or faster than that possible, after considering the additional delays over the data transport.

The scheduling algorithm consists of a configuration routine at initialisation and-run time section to carry out application processing. The initialisation stage begins by first tabulating, in the function reference table, all the function identifier strings matched to function addressees in memory. The application initialisation then parses the SODL structure or file, finding objects and calling an identify function, which returns an object's memory requirements. The object's initialisation function is then called to initialise its allocated memory. The next stage proceeds to read from the SODL file the functions belonging to the object. Each function name is matched in the function reference table and its address is then inserted into the event table at a location defined by its trigger event location. If the function does not have a start event defined, this implies that the function is an input device handling function; in which case it is assigned to an appropriate device driver existing in the operating system.

A data structure containing the references to the data input, output and completion event locations defined from the function in the SODL is inserted into the event table at the same location together with the reference to the object data associated with this function. References to data are simply the locations in a preferred data table allocated to store data produced as the output of processing functions.

After all information in the SODL has been read, the execution of these functions may begin for the application run-time. The run-time operates by firstly enabling any input device functions that are associated with input devices. The token list in the table is then scanned to detect asserted events. When an event is asserted, the token is reset and the associated function is called. The input/output data and object data associated with this instance of the function are defined by the references assigned during the initialisation stage. The function is then responsible for reading data from the input references, carrying out the processing and writing the results to a data table. Finally, the completion event tokens are asserted by the function. The algorithm then continues to scan the token table and the process is repeated for any functions associated with asserted event tokens. When input functions are executed in response to external stimuli, monitored by the device drivers, the functions write data and completion event signals to the data tables and the event tables.

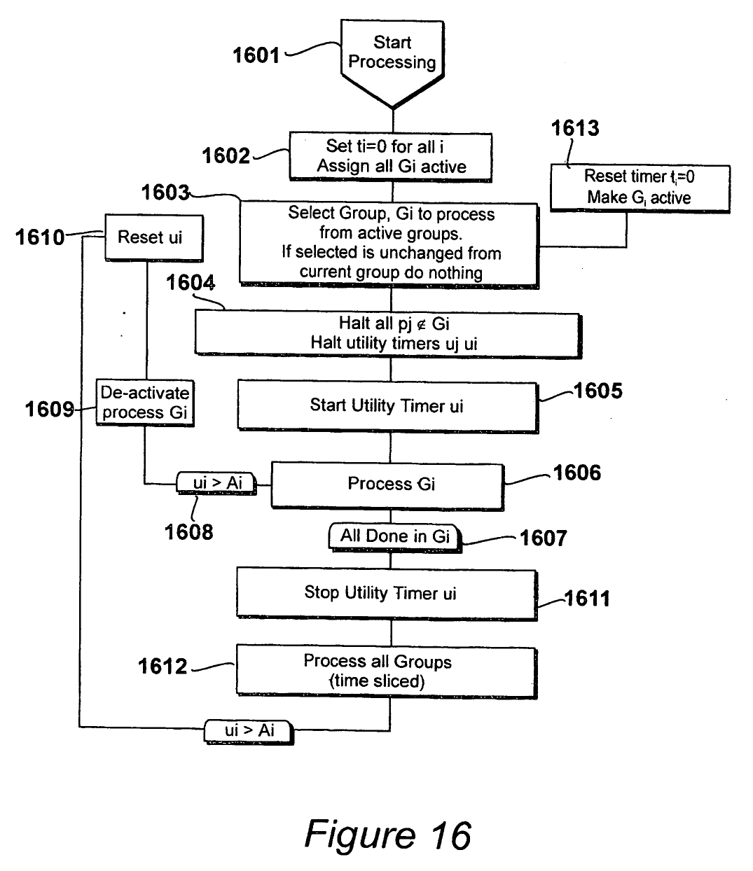

An embodiment of the resource reservation scheduling algorithm is illustrated in FIG. 16, based on the partition in the functions into separate tables or SODL structures. Individually, these tables are each executed as specified previously, for the single table or structure embodiments. As an ensemble, the selection of which table is executed at any given time is co-ordinated by a scheduling algorithm. The priority and duration with which each table is executed is defined by the processing group information in the SODL.

Initially, all groups are made active and a selection is made depending on a scheduling algorithm. Embodiments of the group selection can be based on a rate monotonic (RM) selection or on an earliest deadline first (EDF) selection. Subsequently, periodic timers are used to identify which groups become candidates for processing. Candidate processing groups can be made selectable or active at any given moment in time depending on the expiry of the periodic activation timers. At every event when a new group is activated, the selection criterion (RM or EDF for example) is re-evaluated and if necessary a new processing group is scheduled, which de-schedules the current group or any other processing. Each group has a utility timer that is used to track the amount of time for which the group has been active. If a group is de-scheduled, its utility timer is stopped until the group is re-scheduled. Thus, any processing group may be halted when no more processing is detected, when its resource allocation has been used or when a higher priority task is scheduled.

When a high priority task is scheduled, the utility timer is stopped but not reset in preparation for the stop group being rescheduled whereupon its timer will resume. When its resource allocation has been used, the group is deactivated and may only continue in idle time periods when no other groups are active. When no more processing is detected, the utility timer is stopped and the process is not deactivated. Subsequently, all groups are scheduled for execution. It is not strictly necessary that any prioritisation is given to the groups which may run in this idle time and any time slicing algorithm may be adopted. It may, however, be preferable for prioritisation to be given to active processing groups using the RM or EDF criteria for example, to improve the real-time performance of inter-dependent processing groups.

Processing groups may contain processes that are executed co-operatively during the token table scanning. Threaded functions may also be executed co-operatively when they persist, possibly, indefinitely in the processing group. Processing may be started by initiating the token table scanning and after that waking any sleeping threaded functions associated with the group. Group processing is then ceased by halting the token table scanning and putting threaded processes to sleep.

At step 1601, the scheduling algorithm expects functions associated with dfferent groups to be associated with different partitions of the token table, thereby enabling each group to be executed as a single entity.

At step 1602, all period timers are reset and started and all groups are assigned as being active. A group is selected for processing from the set of currently active groups according to at least a predetermined criterion at step 1603.

The predetermined criterion can be, for example, RM or EDL criteria. Any other group processing that may be currently underway is halted and an associated utility timer is temporarily halted at step 1604.

At step 1605, a utility timer for the new group is started and processing of the group commences at step 1606 until either all processes within the group have been done, as indicated at step 1607, or until it is determined, at step 1608 that the time allocation has been exceeded. Once the time allocation has been exceeded the current group is deactivated at step 1609. The corresponding utility timer is reset at step 1610 and processing continues from step 1603 where the next group is selected for processing.

Preferably, if all of the processing has been completed before the time allocation has been used, the utility timer is stopped at step 1611. At step 1612, the available resources are made available, so that at least one of the processes is executed, such that during the unused allocation for processing group A, all of the processing groups are allowed to execute in a time sliced fashion. Consequently, selected or all tables are scanned and selected or all unfinished threads are enabled. The proportion of processing time allocated to each group is not specifically defined and may, for example, be such that each group is allocated the same duration of processing time. After the allocation for the processing function has expired, the utility timer is reset at step 1613 in preparation for its next time period and the process restarts at step 1603.

At any time during the above algorithm, when a period timer expires, signalling the beginning of a new processing group's time slot, a group is added to the set of active groups, where the corresponding group timer is also reset and the group is made active. A determination is made as to whether or not the newly activated group should pre-empt the currently running group processing. If so, the process continues after step 1603 after which the newly active group with higher priority is initiated at step 1604.

1. A method of supplying instructions to a one or more operational stations, comprising the steps of:
defining operations to be performed at said operational stations as a graphical data flow diagram;
converting said data flow diagram into sets of system description data;
downloading a respective set of data to each of said respective operational stations; and, at each operational station,
parsing said instructions to populate a data table and an event table;
scheduling the execution of events read from said respective tables; and
executing said events in accordance with the aforesaid scheduling step.

2. A method according to claim 1, wherein a plurality of operational stations are present that are manufacturing and/or testing stations.

3. A method according to claim 2, wherein said manufacturing/testing stations are specifically configured for performing a manufacturing operation, wherein the step of downloading said instructions embeds said instructions within an operation station to define an embedded system.

4. A method according to claim 1, wherein said graphical data flow diagram consists of functional icons connected by data links and event links.

5. A method according to claim 4, wherein a first selection of icons and links relate to operations to be performed at a first station and a second selection of icons and links relate to operations to be performed at a second station.

6. A method according to claim 5, wherein data links and/or event links connect an icon in said first selection with an icon in said second selection and, after downloading said instructions, a physical network facilitates communication between said first station and said second station.

7. A method according to claim 1, wherein system description data is object oriented and contains a list of objects specified in the data flow diagram and each of said objects includes a class identifier.

8. A method according to claim 7, wherein there is a list of identifiers indicating events associated with the execution of a procedure.

9. A method according to claim 7, wherein there is a list of identifiers for the input data locations of the procedure and/or the output data locations of the procedure.

10. A method according to claim 7, wherein there is a list of identifiers indicating the completion of processing and the availability of output data.

11. A method of supplying instructions to a plurality of operational stations, comprising the steps of:
defining operations to be performed at said operational stations as a graphical data flow diagram partitioned into sections to be downloaded onto respective distributed processing stations, wherein the distributed processes communicate by sharing data identified by links (arcs) representing at least one item of tagged data or a tagged event;
converting said data flow diagram into sets of system description data;
downloading a respective set of instructions to each of said respective operational stations; and, at each of said operational stations,
parsing said instructions to populate a data table and an event table;
scheduling the execution of events read from said respective tables;
executing said events in accordance with the aforesaid scheduling step; and
implementing communication between distributed embedded processes by the provision of a communication channel between said operational stations.

12. A method according to claim 11, wherein the executing of said events includes making a determination as to whether an event has been triggered and, in response to a determination to the effect that an event has not been triggered, executing a function corresponding to the triggered event.

13. A method according to claim 11, wherein said defining step for defining operations to be performed at the operating stations involves selecting a required function in response to viewing a graphical user interface, such that the processes are displayed as icons with links therebetween by said graphical user interface.

14. A method according to claim 11, wherein the parsing, scheduling and executing steps are performed by a respective event handling system and said event handling system communicates with a data table and an event token table.

15. A method according to claim 14, wherein the event handling system communicates over said communication channel via a real time transport interface.

16. A method according to claim 11, wherein the communication channel is provided by a network configured to interconnect the operating stations.

17. A method of supplying instructions to a plurality of operational stations according to claim 11, further comprising the steps of calculating the real time performance of an application in advance of run time testing using worst case execution times of processing functions within the real time data flow environment by summing dependent worst case execution time of components in a data flow diagram by following control flow links (arcs) in the diagram to yield processing times between nodes of a system.

18. A method according to claim 17, wherein the summation of dependent worst case execution times is queried in response to selecting a pair of nodes in the system.

19. A method according to claim 18, wherein the worst case execution time is displayed.

20. A method of supplying instructions to a one or more operational stations, comprising the steps of:
defining operations to be performed at said operational stations as a graphical data flow diagram;
converting said data flow diagram into sets of system description objects, wherein each object contains
a) a list of identifiers indicating events associated with the execution of functions,
b) a list of identifiers for the functions input data locations,
c) a list of identifiers for the function's output data locations, and
d) a list of identifiers indicating at least one event signalling the completion of processing and the availability of output data;
downloading a respective set of data to each of said respective operational stations; and, at each operational station,
parsing said instructions to populate a data table and an event table;
scheduling the execution of events read from said respective tables; and
executing said events in accordance with the aforesaid scheduling step.
